(19) United States
(12) Patent Application Publication
(10) Pub. No.: US 2024/0301861 A1
(43) Pub. Date: Sep. 12, 2024

(54) SINGLE AND TWIN TURBINE FLUID STREAM ENERGY COLLECTION AND CONVERSION DEVICES

(71) Applicant: Clifford J. McIlvaine, St. Charles, IL (US)

(72) Inventor: Clifford J. McIlvaine, St. Charles, IL (US)

(21) Appl. No.: 18/668,723

(22) Filed: May 20, 2024

Related U.S. Application Data
(63) Continuation-in-part of application No. 18/178,699, filed on Mar. 6, 2023, now Pat. No. 11,988,197.

(51) Int. Cl. F03D 3/04; F03D 3/06; F03D 9/12; F03D 9/25; F03D 9/32

(52) U.S. Cl. CPC F03D 3/04; F03D 3/06; F03D 9/12; F03D 9/25; F03D 9/32; F05B 2220/706

(57) ABSTRACT

A fluid turbine assembly includes a circular housing, one or more turbines placed inside the housing and configured to rotate about a rotational axis, the turbine including a rotor and a plurality of blades which protrude from an outer surface of the rotor, a funnel assembly configured to collect and compress fluid stream energy through a fluid inlet opening, and an intake ducting part of the funnel configured to direct the collected fluid stream energy into the housing and toward the turbine blades in a first direction, and to direct the collected fluid stream energy into the housing and toward the turbine blades in a second direction opposite the first direction at the same time. The funnel is configured to rotate on the same axis independently of the turbine blades.

### CROSS REFERENCE TO RELATED APPLICATIONS

The present application is a continuation-in-part of U.S. patent application Ser. No. 18/178,699, which was filed on Mar. 6, 2023. The entire contents of U.S. patent application Ser. No. 18/178,699 is incorporated herein by reference.

### FIELD OF THE INVENTION

The present invention relates generally to single and multiple turbine devices which collect and convert fluid stream energy into usable electrical and mechanical energy.

### BACKGROUND

Over the years, a number of approaches have been taken around the world to produce large amounts of clean, low cost pollution-free electrical and mechanical energy around the world, in all environmental conditions, to reduce and/or eliminate the use of dirty fossil fuels which are known to cause pollution and health problems. Such approaches have not fully solved the problems of collecting and converting wind, water, and solar energies into usable electrical and mechanical energies.

There is a tremendous need for simple, reliable, pollution free, environmentally safe energy collection and conversion systems that do not kill birds, fish or other living things, plus be able to operate any place in the world under any weather conditions. The present invention can operate in severe weather conditions when the winds blow at 100 miles per hour or more, which is an efficient time to collect and convert wind energy into electrical and mechanical energy, especially when the grid power is down and power is needed to run various devices to survive the storm. The present invention solves many of these problems by keeping the devices simple and efficient for clean energy collection and conversion under a broad range of weather conditions and with applications such as powering batteries, vehicles, homes, larger buildings and factories. The devices can be mass produced, can also be used for hydroelectric energy production, and they are scalable.

### SUMMARY

Devices according to the present application may be designed to typically operate from 5 to 175 miles per hour or more under all weather conditions around the world. As such, turbine rotors for these devices are built with a very heavy solid mass of material, such as stainless steel, cast iron, steel, lead, concrete, glass, or similar such materials. This heavy mass of the main turbine rotor needs to spin at very high revolutions per minute in order to store usable kinetic energy; therefore, each rotor should be precision balanced to prevent premature failure.

The devices use special low friction magnetic bearings which do not require any conventional lubrication oil. This allows the devices to operate from minus 60 degrees Fahrenheit to plus 150 degrees Fahrenheit under all weather humidity conditions. Conventional oil lubricated bearings can also be used under moderate temperature conditions.

Devices according to the present application can generate electricity by incorporating the generator into the turbine itself. A stacked version can effectively double the generator speed under the same wind conditions.

### BRIEF DESCRIPTION OF THE DRAWINGS

FIG. 1 is a top view of a turbine rotor according to exemplary embodiments of the present application.

FIG. 2 is a cutaway top view of a single turbine assembly according to an embodiment of the present application.

FIG. 3 is a cutaway top view of a side-by side twin rotor configuration according to an embodiment of the present application.

FIG. 4 is a cutaway top view of another side-by side twin rotor configuration according to an embodiment of the present application.

FIG. 5 is a cutaway top view of a configuration with a water enhancement according to an embodiment of the present application.

FIG. 6 is a top view of a stationary part of a turbine generator according to an embodiment of the present application.

FIG. 7 is a top view of a rotor of a turbine generator according to an embodiment of the present application.

FIG. 8 is a partial side view of a turbine generator according to an embodiment of the present application.

FIG. 9 is a cutaway side view of a stacked twin turbine opposite rotation assembly according to an embodiment of the present application.

FIG. 10 is a partial cutaway top view of a stacked twin turbine opposite rotation assembly according to an embodiment of the present application.

FIG. 11 is a top view of a center cavity of a fixed funnel side wall.

FIG. 12 is a front view of fixed funnel side view with movable panels in the center cavity.

FIG. 13 is an end view of the movable panels.

FIG. 14 is a front side cutaway view of the movable panels inside the center pocket.

FIG. 15 is a top view looking down of the panels when extended.

FIG. 16 is a front view of the extended panel arrangement.

FIG. 17 is a side view of the extended panel arrangement.

FIG. 18 is a top view of a motor generator arrangement.

FIG. 19 is a side view of a motor generator arrangement.

FIG. 20 is a block diagram of turbine methods.

### DETAILED DESCRIPTION

Set forth below with reference to the accompanying drawings is a detailed description of embodiments of single and twin turbine fluid stream energy collection and conversion devices.

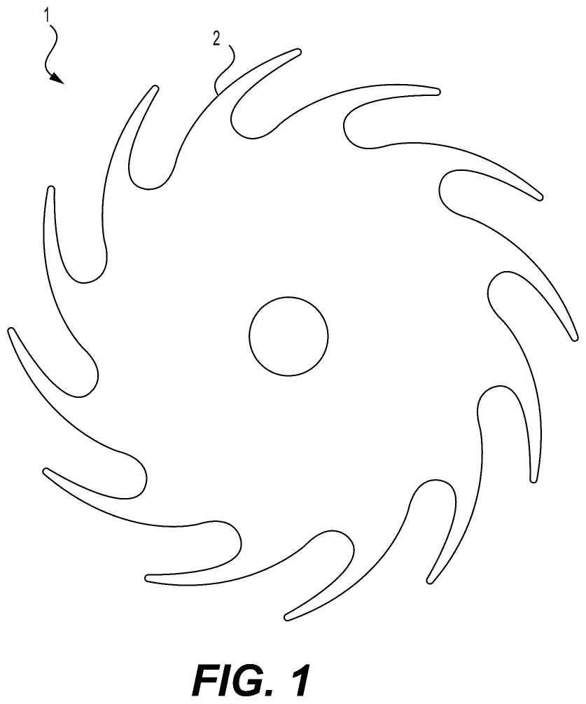

FIG. 1 illustrates a top view of a turbine rotor 1 usable with devices according to the present application. The turbine rotor 1 is designed with special tall curved rotor blades 2. The turbine rotor 1 can be scaled up or down for different uses, with the blades 2 remaining the full height of the turbine rotor 1. In the illustrated example, there are twelve blades 2, but this can of course vary depending on the specific application. As discussed in detail below, the turbine rotor blades 2 are configured to collect fluid stream energy continuously around the circular surface at the same time for maximum mechanical energy transfer to the spinning rotor 1.

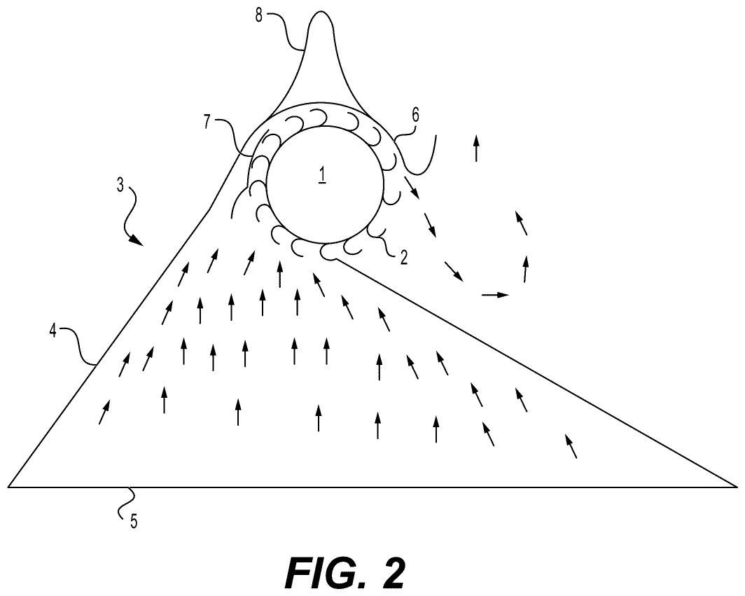

FIG. 2 illustrates a cutaway top view of a single turbine embodiment including a large main funnel and circular housing assembly 3 that is constructed with fiberglass, carbon fiber or other molded super strong plastic materials for light weight, but can be made of heavy metal. Even though the main funnel 4 is constructed of very strong materials, the main funnel 4 is so large, it may not be strong enough to withstand high interruptible pressure volume fluid stream energy conditions without incorporating a structural grid 5 at the front surface face of the funnel, which may be a 2 inch grid.

Various wind conditions where the wind starts and stops all the time cause interruptible conditions of the fluid stream energy, producing extra stress. To compensate for the additional stress on the collection elements, embodiments are configured to automatically reduce the surface area of the collection funnel. In particular, the main funnel 4 can incorporate an attached extended funnel which automatically adjusts its surface area size to pre-determined settings for varying strong wind/fluid stream conditions, including start-stop interruptible, low-, and high-pressure wind conditions. Such extended funnel may incorporate movable panels which fold back (origami technique) or slide back, and a flexible sail with a surface which can fold or roll back in high pressure wind/fluid stream conditions; all these ways change the collection surface area, which reduces the stress on the funnel.

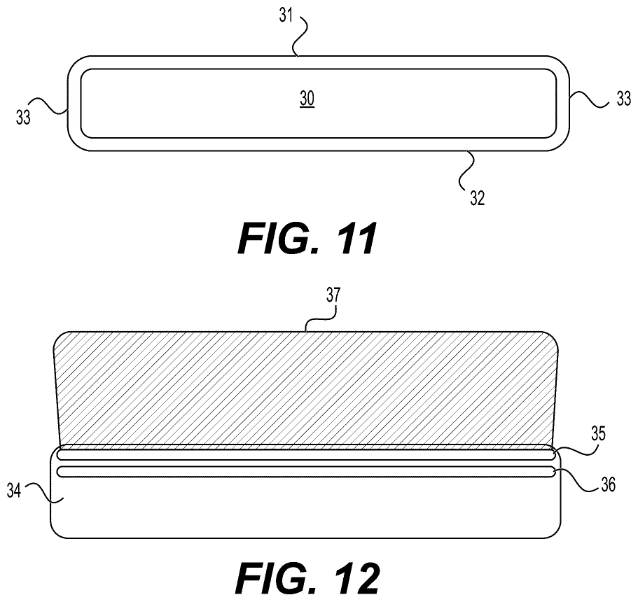

FIG. 11 illustrates a center pocket 30 disposed in one of the fixed funnel side walls which will hold the sliding movable panels. Although only one is illustrated, in an embodiment the four walls defining a fixed funnel will have such a center pocket 30 with sliding movable panels therein. In the FIG. 11 top view, the center pocket 30 is defined by outside wall 31, inside wall 32, and side walls 33.

FIG. 12 is a front view of a fixed funnel wall 34 with two movable panels 35 and 36 disposed therein, in which approximately one foot wide flap part 37 of the extendable funnel movable panels 37 is visible. In the FIG. 12 view, the top flap part 37 overlies the flap part of the second movable panel (not shown). The movable panels 35 and 36 are spring loaded to retract into the center pocket 30 in high wind conditions via pressure on the flap parts which face the fluid stream.

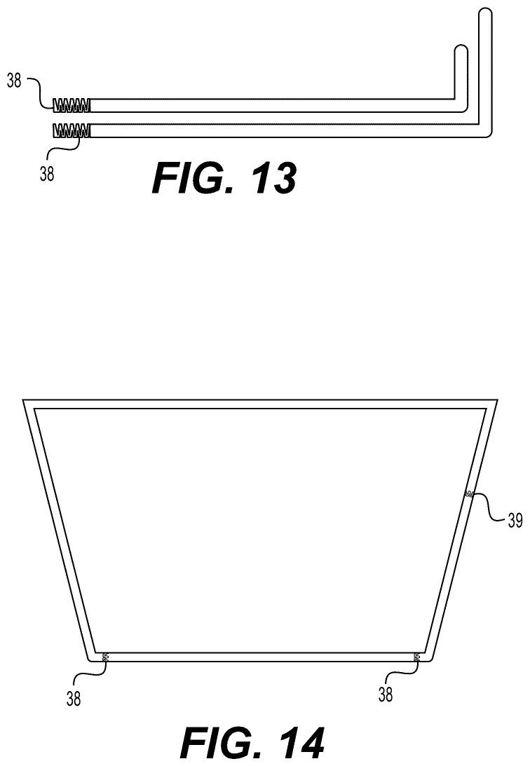

FIG. 13 is an end view of the movable panels, with the bottom springs 38 that cause the movable panels to be spring loaded on the bottom visible. FIG. 14 is a front side cutaway view of the movable panels inside the center cavity. In addition to both panels being spring loaded at the bottom, one of the panels is spring loaded on the left side, and the other is spring loaded on the right side. One of the side springs 39 is visible in the figure. With this arrangement, in low wind conditions, the panels expand sideways and up and down at the same time, to increase their surface area and collect more fluid stream energy.

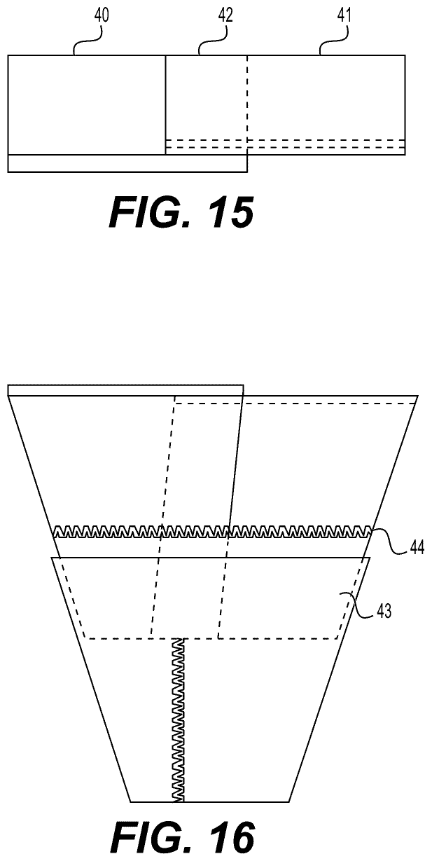

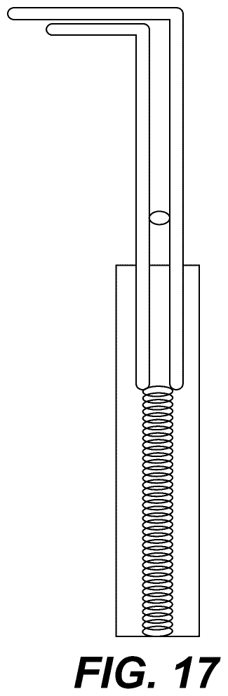

FIG. 15 is a top view looking down of the panels when extended. As seen in the figure, when extended, there is a left panel and a right panel because they are biased in opposite left and right directions. The left panel flap 40 and right panel flap 41 remain overlapped in an overlap area 42 by about ⅓ their total width. Furthermore, as shown in the FIG. 16 front view of the extended panel arrangement, the panels remain within the cavity of the fixed funnel by about ⅓ their total height. Also visible in that figure is a guide channel 44 built into each panel with tension spring force so that they expand left and right, which can be used in addition to or instead of the side springs. Additionally, FIG. 17 is a side view of the extended panel arrangement.

The main funnel 4 is configured with ducting walls 7, which are part of the circular housing funnel assembly 3 which collects, directs, separates, compresses, and recombines in opposite direction the fluid stream energy about 300 degrees around either a single turbine rotor or a !win turbine rotor assembly (discussed in detail below) in a continuous smooth fluid stream pathway around and impinging on the rotor blades 2. This fluid stream starts out in one direction, normally on the left side of the main funnel 4 for a first rotation direction, and ends up exiting the circular housing assembly 3 on the right side front rear of the funnel in the opposite direction, 180 degrees from where it was collected.

For additional efficiency, a very large protrusion 8 on the top and rear of the circular housing assembly 3 is provided to cause the funnel front to always face directly into the fluid stream (for example, the wind stream). Furthermore, a super slippery embedded coating (PTFE or the like substance) on the surface of the funnel 4, circular housing 6 and ducting walls 7 may be used to reduce friction on all the critical surfaces.

In addition, as discussed in detail below, the rotational axis allows the turbine rotor 1, funnel front 4, and the circular housing 6 to rotate independently of each other if necessary. Normally the main funnel 4 and circular housing 6 are molded together to form assembly 3, and rotate as a unit around the rotational axis independently of the turbine rotor 1. In particular, the funnel 4 pivots on the rotational axis using separate magnetic bearings; at the same time, the turbine rotor 1 also pivots on the rotational axis at a different pivot point using its own magnetic bearings independent of the funnel. Each separate function has its own pivot point on the rotational axis, and its own magnetic bearings. Standard oil bearings can be used at reduced life and efficiency, It is also possible to have additional different functions moving around the rotational axis independent of each other at the same time.

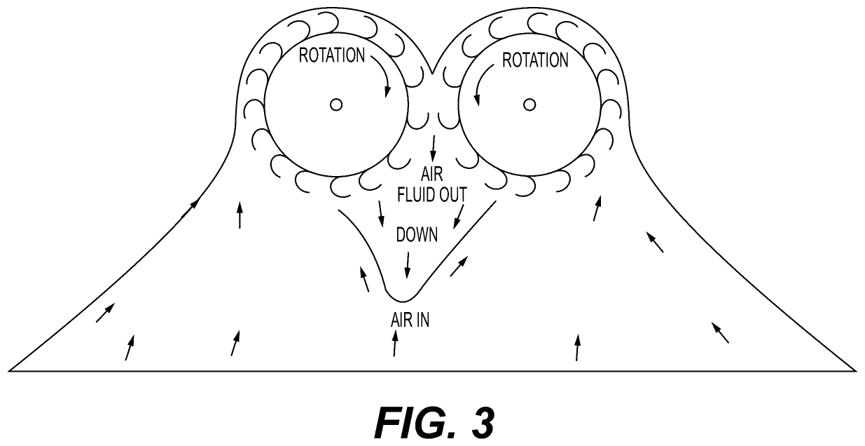

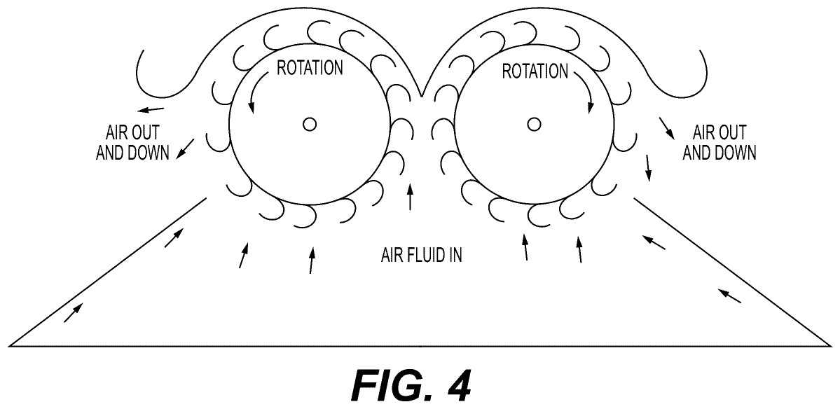

FIGS. 3 and 4 illustrate exemplary side-by-side twin rotor embodiments, each having two separate rotational axes and rotors which are independent of each other. Furthermore, the funnel/housing assembly can share a rotational axis with one of the turbines, with the other turbine being mounted to be carried by and rotate within the funnel housing assembly.

The side-by-side twin turbine devices use the same basic funnel housing fluid stream inlet and exit openings as the single turbine design, with some modifications. In particular, in the FIG. 3 twin turbine embodiment, the air or fluid collected by the funnel is directed to the left and right sides by the internal ducting, so that the turbines spin toward each other from back to front, and the spent air or fluid is exited together in the center of the housing assembly and directed down and out. In the FIG. 4 twin turbine embodiment, the air or fluid collected by the funnel is directed between the two turbines, so that the turbines spin away from each other from front to back, and the spent air is directed out of the assembly from the respective turbines on the respective outer back left and outer back right sides of the housing.

In the side-by-side twin turbine embodiments, the two turbine rotors can either rotate independently of each other or be synced together by a figure eight cog belt or chain arrangement attached to just inside the outer diameter surface of the rotors, just below the blades. Furthermore, both the single and twin turbine funnel assemblies can be mounted high above the ground on a tower or other structure independent of the turbine rotor assembly to save weight, and have the heavy mass turbine rotor assemblies on the ground for easy electrical or mechanical hookup.

When on a high, e.g., 200 foot high tower, the funnel assembly can have, for example, a two foot diameter flexible or solid tube or duct attached to the funnel assembly rear fluid stream opening, transferring from the funnel horizontal axis to the tube vertical axis to convey fluid stream energy down to the turbine rotor assembly on the ground. The inside surface of the vertical tube and funnel collection surface are embedded with super slippery (PTFE or the like) particles to reduce the friction of the fluid stream so maximum energy can be conveyed and transferred to the special tall curved turbine blades on the ground, in one embodiment. The tower funnel rotates directly into the fluid stream, same as the combined assembly does.

If weight is a major problem, and amount of kinetic energy storage from the main turbine rotor assembly is not a concern, and/or the complete collection and production device is required to be high on a tower, the main turbine rotor blade assembly can be hollow and fabricated, for example, from one quarter inch or thinner non-magnetic stainless steel, sprayed up fiberglass or carbon fiber, or molded high strength materials. The hollow turbine rotor assembly can also be pressurized with helium, hydrogen gas mixture, or other lighter-than-air gases. This way it is possible to shed about 90 percent of weight from the turbine rotor blade assembly. Should conditions change, and everything is moved to the ground, where weight is not a factor, the hollow turbine rotor blade assembly can be filled with a heavy liquid. concrete, lead or other heavy mass material. When doing this, extreme care must be used to properly rebalance the turbine rotor blade fabrication assembly.

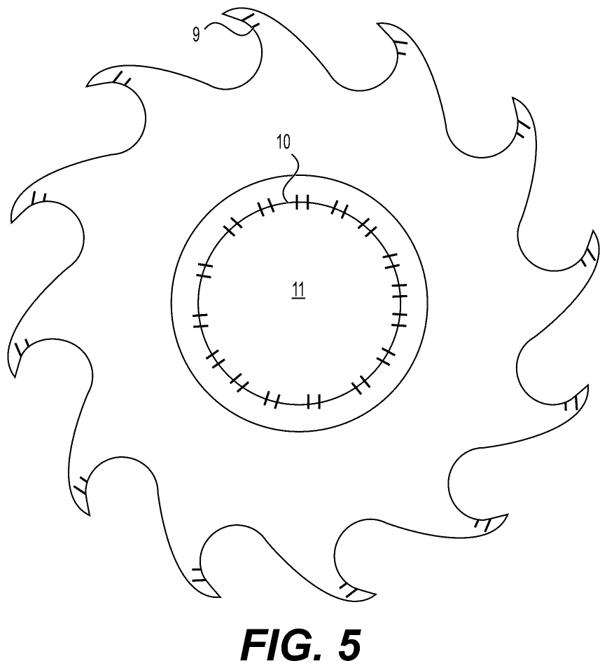

FIG. 5 illustrates an enhancement to the turbine using water. In particular, small holes 9 are provided in the front curved edge of the full height of each blade. Furthermore, a slipring 10 around a center rotor 11 allows high pressure water to enter the center and travel through the rotor to the blades outer edge. This can increase efficiency or even spin the rotor without outside wind or fluid moving. Such an arrangement can also be used, with almost no changes, in both single and twin turbine versions, and can be configured to provide efficient hydro-electric energy to homes and factories. In this use, the large funnel may be eliminated depending on the volume and pressure at the water inlet opening.

Furthermore, to increase efficiency in very hot dry areas of the world, a number of water jets can be installed on either bottom, top, or both main funnel front surfaces. Such nozzles are adapted to produce a mist in the air to make the air denser, so it pushes harder on the turbine blades. A collection housing at the bottom of the turbine assembly holds the water. A liquid pump can be built as part of the turbine rotor assembly to pressurize funnel nozzles, or a stand-alone pump can be hooked to power take-off pulley to run the pump. Sand or other solid particles can also be used.

In addition to the primary main turbine rotor that stores its own energy, there may be secondary storage motor generator units. Each storage motor generator should be configured to be made of very heavy mass material such as stainless steel, cast iron, glass, steel or similar materials contained inside a very high vacuum vessel which can be made out of high-grade non-magnetic material such as stainless steel, glass. or other non-magnetic high vacuum materials, and may spin at very high rotational speed 5000 or more rpm. The secondary storage generator units can be self-contained motor generators, to be precision balanced, similar to the main turbine rotors.

Using motor generator units instead of generator only units allows the main turbine generator to spin up the secondary storage generators in two or more ways, instead of just one way of direct electromagnetic coupling and decoupling to and from the main turbine rotor. This action is very simple and works very well at high wind or fluid speeds. It may not work as well at low wind or fluid speeds because the main rotor is spinning much slower and cannot give the secondary storage generator its maximum energy charge. To overcome this deficiency, electrical power energy produced by the main turbine rotor may be used to power up the motor on the secondary generators, which is used to spin the generator up to full energy storage capacity at low wind speeds.

Another advantage of the high vacuum motor generator arrangement is that it allows more than just the one direct coupled storage unit. This allows multiple output electrical power circuits and great amounts of diversified electrical storage capacity. This storage method is simple, reliable, and far better than the best batteries which tend to fail in cold weather, because it may be trouble-free for an extended life. The secondary motor generator high vacuum units can last a lifetime when using special low-friction magnetic bearings properly balanced and properly sealed in a high vacuum chamber.

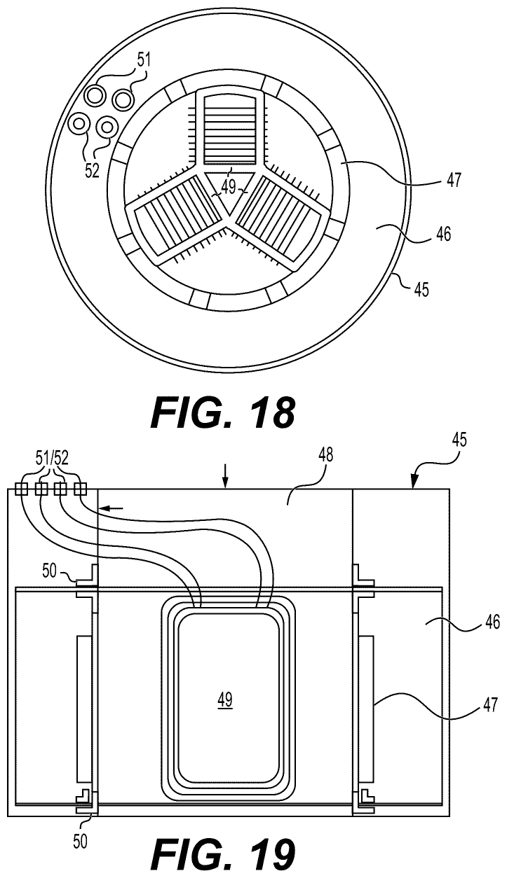

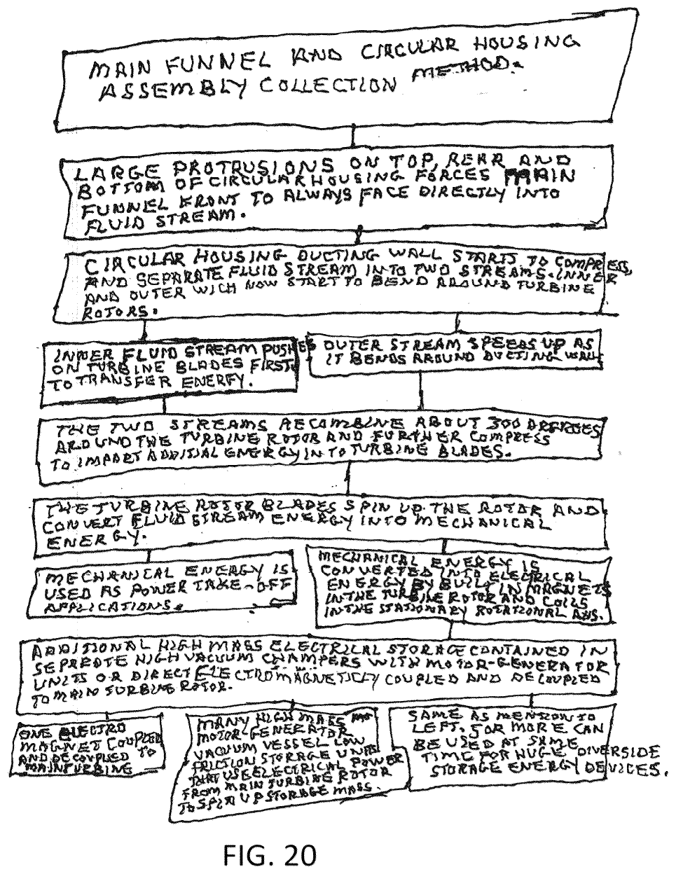

As illustrated in FIGS. 18 and 19, the motor generator is disposed in a vacuum chamber 45 of non-magnetic stainless steel. Embedded in the heavy mass steel rotor 46 are special high power ceramic magnets 47. In the center stationary tube 48 are one or more center iron cores 49 around which copper coils are wound. Two separate coils can be wound-one for spinning up and one for power generation. Alternatively, a separate motor can be places on top of the heavy mass rotor. The rotor spins on high power magnetic bearings 50, the top pair of which attract each other, and the bottom pair of which repel each other. The windings are wired to hermetic glass to metal high vacuum electrical connectors 51 and 52 for main generator power out (connectors 51), and spin up motor in (connectors 52).

Another embodiment first for the secondary storage generator units and main turbine rotor assemblies is they are wound with flat copper iron alloy cladding wire for the windings and super strength ceramic magnets. Standard round copper wire windings and Alnico 5 magnets can be substituted at reduced efficiency.

The main turbine rotor generator is made the same way as the secondary generator, except it need not be disposed in a high vacuum environment. Also separate conventional generators may be placed next to the wind turbine assembly and driven in conventional manner such as by a belt pulley arrangement, chain sprocket arrangement, or gears, or the like, instead of or in combination with the main turbine rotor generator. Further, mechanical power take-off devices can be used by any of the above mentioned ways or more, to extract mechanical energy.

The main turbine rotor can be configured to generate electrical energy in more than one way. A preferable arrangement involves embedding the high-power magnets heightwise in the very center of the main turbine rotor, right next to the stationary rotational axis, where the special flat copper iron alloy cladding rectangular windings are placed. The coil windings are also tall and narrow to match the profile of the magnets. If this arrangement is reversed, then slip-rings need to be used on the main rotor side to convey the electrical power from the generator, for use. One or more magnets can also be used on the bottom and top of the main turbine rotor, and the coil windings on the stationary housing next to the magnets. The tall narrow blades of the turbine rotor are specially curved to collect and hold momentarily the fluid stream particles so the maximum fluid stream energy is transferred to the turbine rotor.

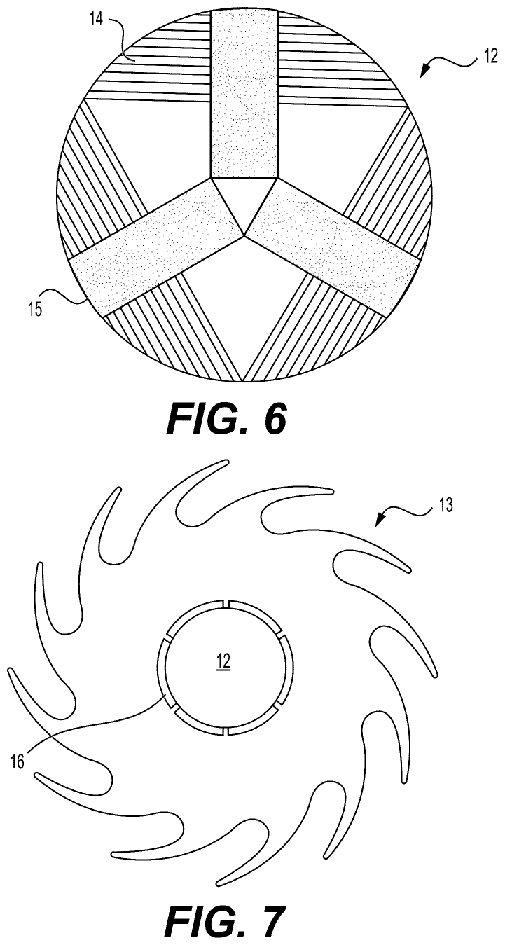

FIGS. 6 and 7 illustrate exemplary components of a single turbine assembly that acts as a generator. In particular, FIG. 6 illustrates a top view of the stationary part 12, around which the rotor 13, a top view of which is illustrated in FIG. 7, rotates. The stationary part 12 includes a plurality (in the embodiment, three) copper windings 14 almost the entire height of the core 12, which are would around respective (in the embodiment, three) iron center iron cores. Alternatively, copper-iron alloy cladding flat wire windings can be used. Embedded in the rotor 13, to surround the stationary part 12, are a plurality (in the embodiment, six) ceramic magnets 16. The rotation of the turbine 13 will thus generate electricity in the windings 14, which can be transferred external to the generator in a known matter.

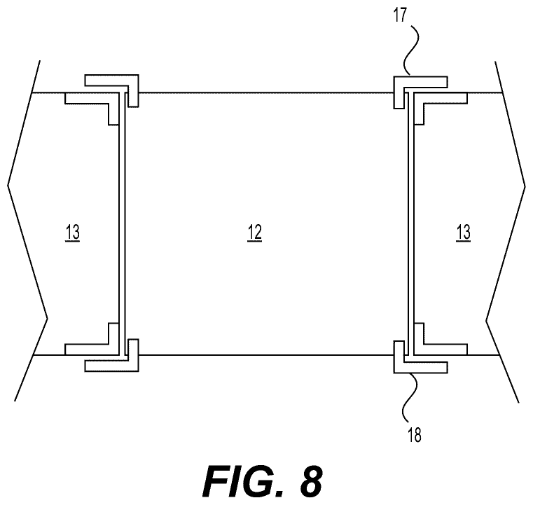

As illustrated in the FIG. 8 partial cutaway side view, the turbine 13 is supported to rotate relative to the stationary part 12 by a top magnetic bearing 17 and a bottom magnetic bearing 18. In the top magnetic bearing 17, the bearing parts are polarized such that the bearing part carried by the stationary part 12 attracts the bearing part carried by the turbine. By contrast, in the bottom magnetic bearing 18, the bearing parts are polarized such that the bearing part carried by the stationary part 12 repels the bearing part carried by the turbine 13. With this configuration, the magnetic bearings 17 and 18 can provide sufficient force to support the turbine 13. Additionally the funnel housing is supported for rotation by the bearing parts carried by the stationary part 12, which interact with additional magnetic bearing parts supported by the funnel assembly.

Another version is the twin turbine vertical slacking version and counter rotation configuration to achieve double generator rpm in low wind or fluid speeds to produce double the power. At low wind or fluid speeds, this vertical stackable version may be the most efficient. This configuration can either use one funnel and direct one fluid stream to each turbine, or stack two funnels, turbine rotor assemblies on top of each other. Stacking two funnel turbine assemblies on top of each other may be the best way to double the electrical power in low wind or fluid conditions. The major difference is the top turbine rotor connects directly to an additional sleeve that slides over the stationary rotational axis and spins coil windings, in a second direction, counterclockwise, while the bottom turbine rotor spins in the first direction, clockwise. The top rotor does not have any magnets. Only the bottom turbine rotor has the magnets embedded in the rotor. The center coil windings now need sliprings on the rotational axis to convey the electrical power generated.

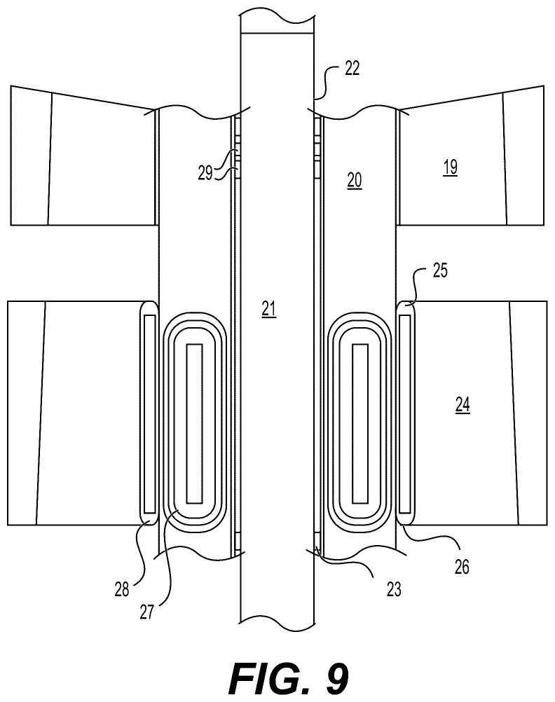

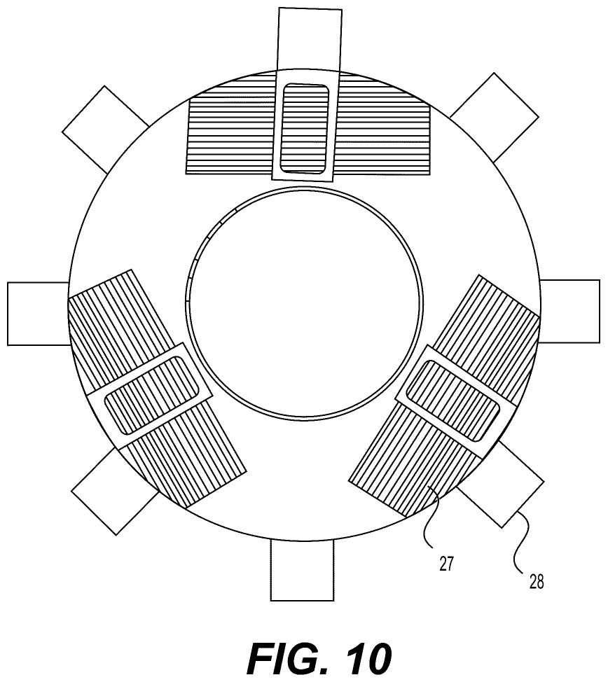

FIGS. 9 and 10 illustrate a stacked twin rotor embodiment configured for doubling the relative generator speed and thus correspondingly increasing the electricity generation. As illustrated in the FIG. 9 cutaway side view, a second rotor 19, which is fixed to a sleeve 20, is configured such that the second rotor 19 and sleeve 20 are supported to rotate together relative to a fixed central axis 21 by a first top magnetic bearing 22 and a first bottom magnetic bearing 23, while a second rotor 24 is configured such that it is supported to rotate relative to the sleeve 20 by a second top magnetic bearing 25 and a second bottom magnetic bearing 26. The magnetic bearings 23, 24, 25 and 26 are similar to the magnetic bearings 17 and 18 of the embodiment of FIGS. 6-8.

The blades of the respective first and second rotors 19 and 24 are oriented oppositely, in other words, as if one of the rotors is flipped relative to the other. The rotors 19 and 24 thus will spin in opposite directions. One or more funnel assemblies (not shown for ease of understanding) designed corresponding to the configurations discussed above are used to direct fluid to the rotors 19 and 24. The rotors 19 and 24 can share a common funnel assembly or use separate funnel assemblies.

Embedded in the sleeve 20 are a plurality of windings/core assemblies, or windings, configured similarly to those of the stationary part 12 in the embodiment of FIGS. 6-8, while embedded in the second rotor 24 are a plurality of ceramic magnets 28. The relative rotation of the first and second rotors 10 and 24 in opposite directions will thus generate electricity in the windings 27. The generated electricity in the windings 28 is transferred to sliprings 29 that are between the sleeve 20 and the fixed central axis 21 via internal wiring in the sleeve 20, for further transfer by internal wiring in the fixed central axis 21.

These devices are scalable and can be mass produced in all sizes. For example, a very small unit a foot or so in diameter is built to charge batteries on electric vehicles while moving or stationary. A large turbine rotor 200 feet in diameter could provide electrical energy for a small town. A medium size turbine rotor 8 feet in diameter and 3 feet high could provide electrical energy for most houses and small businesses. The main funnel for this size turbine rotor would be a main solid fixed funnel about 10 feet deep (front to back) by 15 feet high and 30 feet wide. The attached controllable variable extendable funnel can be a lot larger. The 8-foot diameter turbine rotor can produce over 100 kilowatts of electrical energy AC or DC.

The detailed description above describes embodiments of wind, fluid turbine assemblies. The invention is not limited, however, to the precise embodiments and variations described. Various changes, modifications and equivalents can be effected by one skilled in the art without departing from the spirit and scope of the invention as defined in the accompanying claims. It is expressly intended that all such changes, modifications and equivalents which fall within the scope of the claims are embraced by the claims.

What is claimed is:

1. Fluid stream energy conversion apparatus comprising:
one or more turbines mounted inside a housing and configured to rotate about one or more rotational axes, the turbine including a rotor and a plurality of blades which protrude from an outer surface of the rotor, and an extended funnel having front inlet and exhaust openings and configured to collect and compress fluid stream energy through the inlet opening, wherein the turbine assembly is configured to direct the fluid stream energy collected by the funnel, and further including adjustable inlet surface area means to vary the inlet surface area according to predetermined set fluid flow values.

2. The fluid stream energy conversion apparatus according to claim 1, further comprising a generator mechanically connected to the turbine to generate electrical energy as the turbine rotates about the rotational axis.

3. The fluid stream energy conversion apparatus according to claim 1, further comprising means to direct the funnel to rotate such that the fluid inlet opening always faces directly into the fluid stream.

4. The fluid stream energy conversion apparatus according to claim 1, wherein said turbine is a main turbine wherein the main turbine generates kinetic energy, further comprising a high vacuum chamber and a secondary electric generator contained in the high vacuum chamber and wherein said turbine is configured to be electromagnetically coupled and decoupled with the main electric generator to store kinetic energy generated by the main turbine.

5. The fluid stream energy conversion apparatus according to claim 1, further comprising a grid, said grid comprising a structural part of the funnel front configured to reinforce the funnel in strong wind conditions.

6. The fluid stream energy conversion apparatus according to claim 1, wherein the extended funnel includes panels which fold back (origami technique) when the pressure of the fluid stream reaches a predetermined setting.

7. The fluid stream energy conversion apparatus according to claim 1, wherein the extended funnel includes panels which slide back when the pressure of the fluid stream reaches a predetermined setting.

8. The fluid stream energy conversion apparatus according to claim 1, wherein the extended funnel includes a sail of flexible material having a surface and configured to roll back or fold back (origami technique) when the pressure of the fluid stream reaches a predetermined setting.

9. A fluid turbine assembly comprising:
a circular housing;
one or more turbines placed inside the housing and configured to rotate about a rotational axis, the turbine including a rotor and a plurality of blades which protrude from an outer surface of the rotor;
a funnel assembly configured to collect and compress fluid stream energy through a fluid inlet opening; and
an intake ducting part of the funnel configured to direct the collected fluid stream energy into the housing and toward the turbine blades in a first direction, and to direct the collected fluid stream energy into the housing and toward the turbine blades in a second direction opposite the first direction at the same time;
wherein the funnel is configured to rotate on the same axis independently of the turbine blades,
wherein the circular housing has ducting walls which separate, compress, direct, and recombine the fluid stream energy in opposite directions.

10. The fluid turbine assembly according to claim 9, further comprising a vertical tube or duct connected to the funnel assembly which may be 200 feet above ground, separate from main turbine assembly.

11. The fluid turbine assembly according to claim 9, further comprising a continuous smooth fluid pathway around the rotor, which allows the turbine to rotate by collecting fluid stream energy continuously 300 degrees around the rotor.

12. The fluid turbine assembly according to claim 9, further comprising a funnel configured to direct the fluid stream energy into the housing in the first direction to the left toward the turbine blades; the fluid turbine housing further comprising an intake ducting portion of the funnel and configured to direct the collected fluid stream energy into the housing toward the turbine blades in a second direction opposite the first direction, at the same time.

13. The fluid turbine assembly according to claim 9, further comprising a large protrusion molded into the housing top and rear to direct the funnel intake ducting to align itself directly into the oncoming fluid stream in the first and second directions.

14. The fluid turbine assembly according to claim 9, further comprising an energy storage means having substantial storage mass contained inside a high vacuum, non-magnetic chamber, so its mass can store energy when electromagnetically coupled to the main turbine rotor, then decoupled to store its kinetic energy, plus use its built in motor for full charge in low wind conditions.

15. The fluid turbine assembly according to claim 9, wherein the fluid turbine assembly is configured to be mounted to an electric vehicle having batteries and configured to charge the batteries, while moving or stationary.

16. A method of converting fluid stream energy into mechanical energy, comprising:
collecting and compressing fluid stream energy into a surround housing which creates two fluid streams;
immediately pushing, by the first fluid stream, on special curved tall turbine rotor blades of one or more turbine rotors, the blades collecting and momentarily holding fluid stream energy particles, and causing the turbine rotor or rotors to absorb fluid stream energy which converts into mechanical energy, which causes the rotors to spin;
causing the second fluid stream to travel about 180 degrees around the circular housing, speeding up before merging with the first fluid stream which further compresses, causing additional fluid stream energy to be absorbed into the turbine rotor or rotors from the opposite direction; and
finishing the fluid stream travel and exiting the housing at about 300 degrees, around the turbine rotor.

17. The method according to claim 16, wherein the mechanical energy produced can be used for power take-off applications, while the built-in turbine rotor magnets interact with the stationary flat copper/iron alloy cladding coil windings to convert mechanical energy into electrical power energy, which is stored by the very heavy mass turbine rotors and used.

18. The method according to claim 16, wherein there are two stacked turbine rotors, one turbine rotor spinning in the first direction, clockwise, and the other turbine rotor spinning in the second direction, counter-clockwise, causing the magnets and coil windings to spin in opposite directions at the same time, which doubles the speed of the generator and power output of the generator, without increasing turbine rotor speed.

19. Single and multi-turbine energy collection and conversion devices comprising:
one or more heavy mass turbines mounted inside a circular housing assembly, and configured to rotate about one or more rotational axis;
the turbine rotor consists of a plurality of blades which protrude from the outer surface of the rotor;
plus a main and extended funnel having front surface fluid inlets and fluid exhaust openings, which are configured to collect, direct, compress and expel used fluid stream energy around the turbine rotor blades in a smooth, continuous pathway around the circular housing to contact the blades;
the extended funnel incorporates adjustable inlet surface area means to vary the inlet surface area according to predetermined fluid flow settings;
wherein the vertical stacking version is configured to rotate one rotor clockwise while the second rotor rotates counterclockwise at the same time, causing the built in generator to rotate twice as fast as the turbine rotors, producing twice as much energy as other configurations.

20. The single and multi-turbine fluid energy collection and conversion devices according to claim 19, further comprising a circular housing composed of fiberglass, carbon fiber, molded plastic, steel, aluminum and like materials.

21. The single and multi-turbine fluid energy collection and conversion devices according to claim 19, wherein all movable functions use either conventional oil lubricated bearings or low friction magnetic bearings.

22. The single and multi-turbine fluid energy collection and conversion devices according to claim 19, wherein main funnel is configured with all funnel walls having built-in pockets to accommodate extended funnel panels.

23. The single and multi-turbine fluid energy collection and conversion devices according to claim 19, wherein all versions of the turbine rotors, movable funnel, and any other functions all have different pivot points on their respective rotational axis, and have their own magnetic bearings.

24. The single and multi-turbine fluid energy collection and conversion devices according to claim 19, wherein all critical surfaces are embedded with PTFE or the like substance to reduce friction.

25. The single and multi-turbine fluid energy collection and conversion devices according to claim 19, wherein the main turbine rotors are very heavy mass and spin at very high RPM to store kinetic energy.

26. The single and multi-turbine fluid energy collection and conversion devices according to claim 19, wherein all turbine rotors are precision balanced.

27. The single and multi-turbine fluid energy collection and conversion devices according to claim 19, wherein all self contained secondary stand alone generator storage units are contained in a high vacuum environment, and can be used for diversified electrical power distribution.

28. The single and multi-turbine fluid energy collection and conversion devices according to claim 19, wherein to improve efficiency in hot dry areas, water jets are installed along main funnel front top and bottom surfaces to make air more dense.

29. The single and multi-turbine fluid energy collection and conversion devices according to claim 19, wherein side by side twin turbines are synced together in a figure eight arrangement.

30. The single and multi-turbine fluid energy collection and conversion devices according to claim 19, wherein main turbine rotor can be hollow and fabricated of ¼ inch stainless steel.
